(19) United States
(12) Patent Application Publication
(10) Pub. No.: US 2017/0263164 A1
(43) Pub. Date: Sep. 14, 2017

(54) HINGE SYSTEM

(71) Applicant: FORMETCO, INC., Duluth, GA (US)

(72) Inventors: John D. GIBB, Buford, GA (US); Chris ADAMS, Hoschton, GA (US); Brian JEFFRIES, Duluth, GA (US)

(21) Appl. No.: 15/068,238

(22) Filed: Mar. 11, 2016

(51) Int. Cl. G09F 15/00; E05D 5/02; E05F 1/12; E05D 11/06; E05D 7/00

(52) U.S. Cl. CPC G09F 15/0025; E05D 11/06; E05D 7/0045; E05F 1/1246; E05D 5/02

(57) ABSTRACT

A hinge for use in a billboard framing system comprising a stationary plate and a rotating plate. The hinge has a curved recess and motion limiting track in the stationary plate that retain a mating feature on the rotating plate. A load distribution feature on the first plate conforms to and contacts an exterior surface on the rotating plate in the open position.

### FIELD

The present disclosure relates, in exemplary embodiments, to hinges. Exemplary embodiments relate to hinges that form a tension joint for holding and maintaining an item, such as a billboard frame, in an open or closed configuration.

### BACKGROUND

Advertising billboard or commercial signage comprising display sheets in the form of printed words, photographs, or drawings on flexible semi-translucent media, such as vinyl, polyethylene, or polypropylene sheets attached to or stretched over a metal or wooden substrate, have been in use for many years. In some instances, the display sheets are attached to the substrate, which forms the billboard face, by an apparatus, such as a cable tensioning system attached to either the front or the back the substrate. When frontal attachment is used, a decorative trim is mounted to create a picture frame.

Unlike a picture frame, there is a gap of several inches between the trim and the frame. The gap may be noticeable up close and create an undesirable distraction. Moreover, the gap between the trim and the substrate billboard may directly expose the cable tensioning system to debris accumulation and weather deterioration. A recent example of a frame mechanism is disclosed in US Application Publication No. 201210159823 (commonly assigned and incorporated herein by reference) attempts to solve this problem by providing a closed trim to conceal the cable tensioning system.

It would be desirable to have a hinge system that could hold the plates of a billboard frame in open and closed positions, with interfacing recesses and protrusions having closely configured complementary geometry which will minimize or eliminate undesirable extraneous movement within the hinge interface. It is further desirable to have a hinge system with contacting surfaces inside of and outside of the hinge recess to minimize or eliminate movement within the hinge in both the open and closed positions and excess movement or “play” in the hinge during movement between the positions. It would further be desirable to have a hinge system with a load relief surface to provide load and stress distribution outside of the hinge recess when the hinge is in the open position.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Generally described, the present disclosure provides in a first exemplary embodiment a hinge comprising a receiver having a curved interior recess and a motion limiting track located between a proximal and a distal end of the curved interior recess, a mating feature having a curved shape and rounded distal end with a protrusion located proximate to the rounded distal end, and a joint formed between the receiver and the mating feature. The mating feature is shaped to translate along the curved interior recess of the receiver. The protrusion is configured to translate along the motion limiting track. The rounded distal end contacts the distal end of the curved interior recess and the protrusion contacts a distal end of the motion reducing track in an opened position.

According to another aspect, a hinge system for use in a billboard frame comprises a stationary plate having a receiver with an interior curved recess, a face plate configured to rotate about the stationary plate having a mating feature that extends into the receiver to form a hinge, and a load distribution feature having a curved surface adjacent the receiver on the stationary plate. The curved surface of the load distribution feature supports an adjacent exterior surface of the face plate and is in continuous contact with the adjacent exterior surface when the hinge is in an open position.

In another exemplary embodiment, a hinge for use in a billboard frame is provided comprising a stationary plate having a distal receiver with an interior curved recess including a motion limiting track, and a load distribution surface proximal to the distal receiver. The hinge includes a face plate having a proximal exterior surface and a distal mating end that has a distal rounded end and a protrusion extending proximal to the distal rounded end, the face plate forms a joint with the distal receiver end, the joint configured to allow movement of the face plate between opened and closed positions, and means for preventing further movement in the opening direction when the face plate is in the opened position so that force and load are distributed at multiple points between the stationary plate and the face plate. In some embodiments, the means for preventing further movement comprises contact between the receiver recess and the distal rounded end, contact between the protrusion and a distal end of motion limiting track, and contact between the load distribution surface and an exterior face surface of the face plate.

In exemplary embodiments, a hinge is provided, comprising a receiver having a curved interior recess and a motion limiting track located between a proximal and a distal end of the curved interior recess; a mating feature having a curved shape and rounded distal end with a protrusion located proximate to the rounded distal end; and a joint formed between the receiver and the mating feature, wherein the mating feature is shaped to translate along the curved interior recess of the receiver and the protrusion is configured to translate along the motion limiting track so that the rounded distal end contacts the distal end of the curved interior recess and the protrusion contacts a distal end of the motion reducing track in an opened position.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a schematic perspective view of a hinge assembly according to one exemplary embodiment integrated into extruded walls of a billboard frame system in an open configuration;

FIG. 1A is a schematic perspective view of the hinge assembly of FIG. 1 in a closed configuration;

FIG. 2 is a side view of a stationary plate of the hinge of FIG. 1;

FIG. 2A is a close-up view of the distal end of the stationary plate of FIG. 2 taken at A;

FIG. 3 is a side view of a face plate of the hinge of FIG. 1;

FIG. 3A is a close up view of the distal end of the face plate of FIG. 3 taken at B;

FIG. 4 is a side view of the hinge of FIG. 1 in an open configuration; and,

FIG. 5 is a side view of the hinge of FIG. 1 in a closed configuration.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

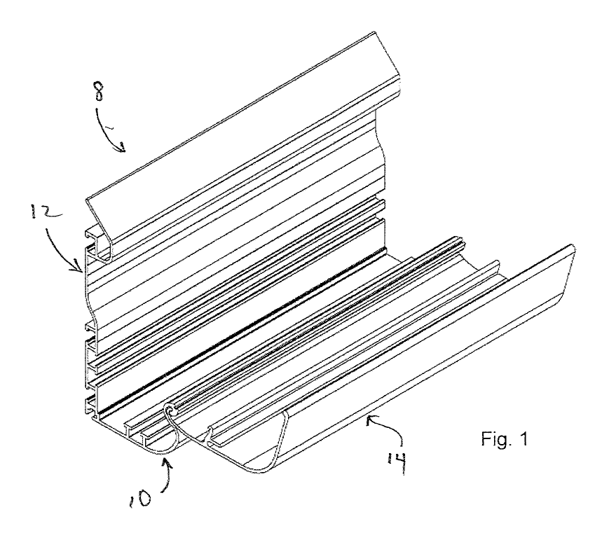

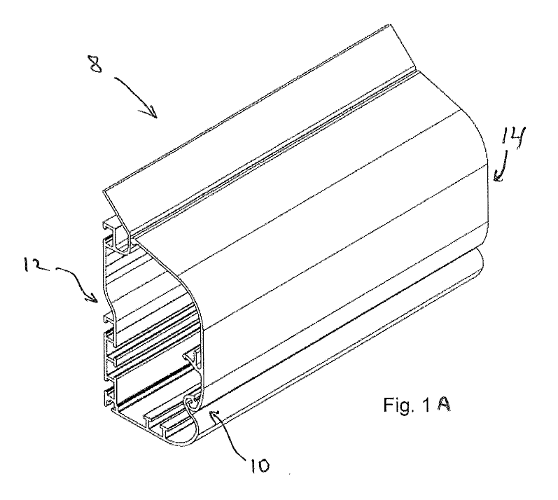

In exemplary embodiments, the present disclosure relates to a hinge or joint that may be used, for example, to form a frame for a tension billboard frame. FIG. 1 illustrates one exemplary embodiment of the present disclosure showing a hinge 8 taking the form of a frame with a joint 10 formed by the end of two plates 12, 14. Distal end of stationary plate 12 receives distal end of face plate 14, or rotating plate, to form the joint 10. Plates 12, 14 may be extruded, stamped, bent, shaped or formed sections and may be made from suitable polymers, plastic, metal, alloy, ceramic, or combinations thereof. It is to be understood that plates 12, 14 can be any length or segment of any generally rigid or semi-rigid material.

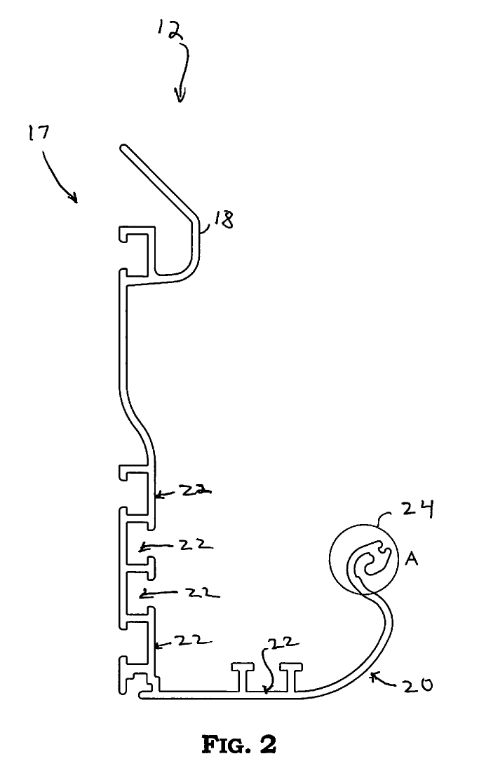

As seen in the exemplary embodiment shown in FIGS. 2-2A, stationary plate 12 is L-shaped and includes a proximal end 17 having, in one exemplary embodiment of a hinge for a billboard system, a flat surface 18 and an S-shaped distal end 20. In between the proximal end 17 and distal end 20 may, in exemplary embodiments, be a plurality of brackets 22 located interior and exterior to the plate 12. Optional brackets 22 on the interior side are configured to support components mounted within the frame such as a display sheet and cable tensioning system for a billboard (not shown). Brackets 22 may also be configured to mount the frame to an exterior component (not shown) by accommodating bolts or other fasteners.

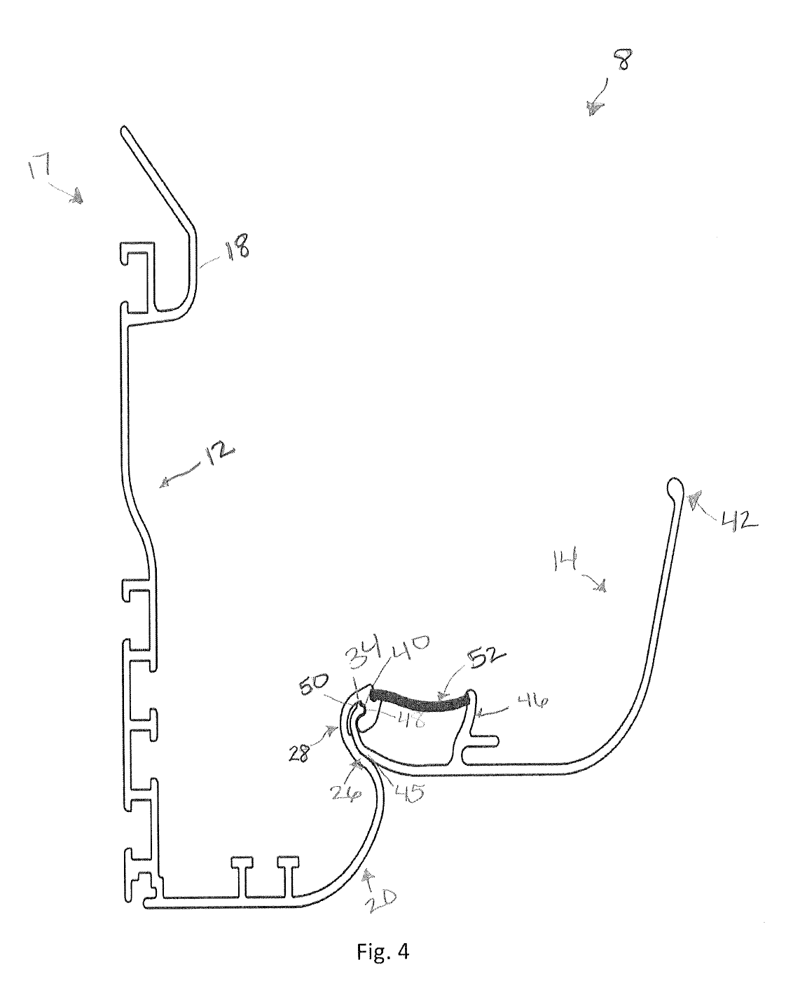

Distal end 20 defines a receiver 24 at A and a face plate load distribution feature 26 (see FIG. 4) providing a surface for face plate 14 to rest on in the open position as further described below with respect to FIG. 4. Receiver 24 has a curved interior recess 28 opposite a smaller exterior recess 30. Curved interior recess 28 includes motion limiting track 32 therein that is a groove further recessed into and extending along a portion of the curved recess 28. The motion limiting track 32 has a proximal end 34 and a distal end 36 and is shorter than the length of the curved recess 28. Proximal end 34 and distal end 36 of the motion limiting track 32 lie between a proximal 38 and distal end 40 of the curved recess 28.

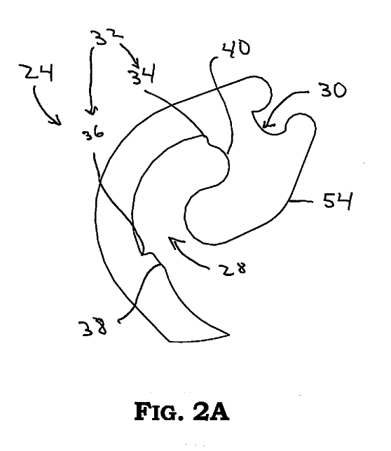

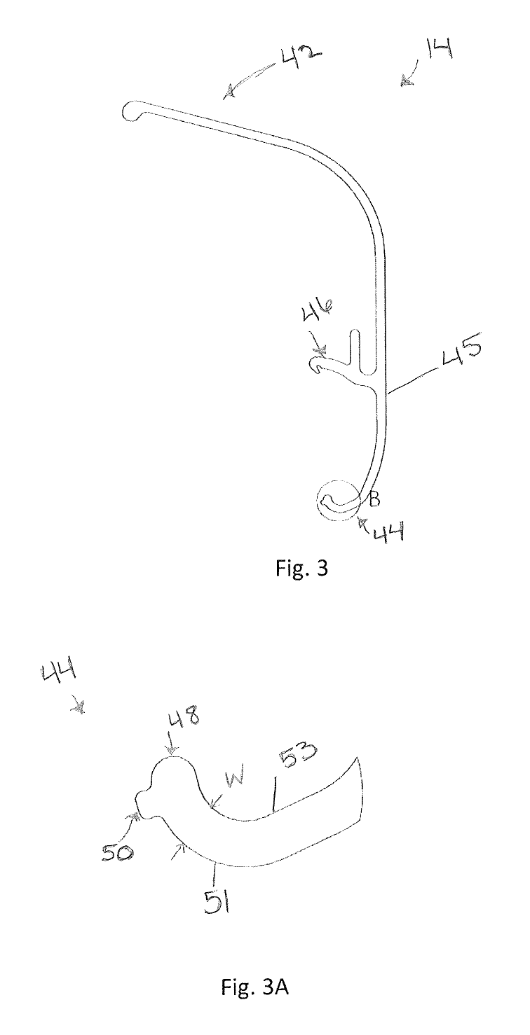

FIGS. 3-3A illustrate an exemplary face plate 14 having a proximal end 42, a distal end mating feature 44 at B, and an arm 46 that lies between the proximal and distal ends 44, 42 and extends at an angle to the proximal and distal ends 44, 42. Face plate 14 has a front surface 45 that, in exemplary embodiments, faces the viewer when installed on a billboard, and provides an uninterrupted smooth frame-type trim extending between the proximal end 42 and mating feature 44. Mating feature 44 is a curved arm with a rounded end 48 and a protrusion 50 extending from a convex surface 51 of the curved arm prior to and adjacent the rounded end 48. Rounded end 48 of mating feature 44 is formed to not be larger than the cross sectional width “w” of the curved arm of the mating feature 44 as seen in FIG. 3A. The protrusion 50 has a uniform symmetric geometry, for instance flat topped with curved sidewalls as shown. Mating feature 44 is configured to translate and rotate within the receiver 24 as discussed in further detail below.

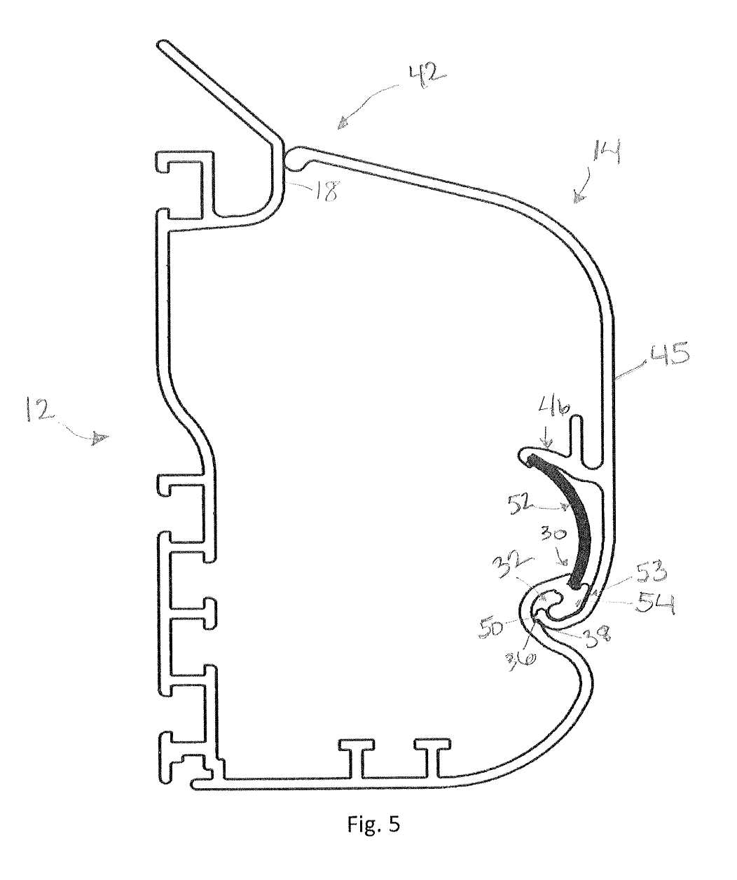

FIGS. 4-5 show an exemplary embodiment of a hinge system or frame 8 in the closed (FIG. 4) and open (FIG. 5) positions that are freely maintained without additional support or force. In this embodiment the mating feature 44 is shown inserted in the corresponding curved recess 28. In some embodiments, the mating feature 44 and the curved recess 28 are dimensioned so that at least a portion of the mating feature 44 remains in contact with the curved recess 28 during translation between the opened and closed positions. In some embodiments, the mating feature 44 and the curved recess 28 are dimensioned so that at least a portion of the protrusion 50 and another portion of the mating feature 44 remains in contact with the curved recess 28 during translation between the opened and closed positions. The hinge system 8 may further optionally include a tension spring 52, such as a leaf spring mounted between exterior recess 30 of the receiver 24 and the arm 46 of the face plate 14 in a compressed state, reducing excess movement within and at the joint 10 and biasing the hinge system 8 in the closed configuration.

In the open position, the rounded end 48 of the mating feature 44 is in contact with the distal end 40 of curved recess 28. Protrusion 50 also contacts distal end 36 of the motion limiting track 32 further limiting any movement of the face plate 14 within the curved recess 28. In the open position, front surface 45 of face plate 14 rests on load distribution surface 26 so that the face plate 14 is further prevented from excess movement, and further movement in the opening direction, and so that the system freely maintains the open position. In the open position the face plate 14 contacts and distributes stress at the rounded end 48 and the protrusion 50 of the mating feature 44 as well as the front surface 45 that lies proximal to the mating feature 44. As illustrated, the hinge 8 is configured so that the face plate 14 comes to rest in the open position in FIG. 4 approximately 90 degrees from the closed position illustrated in FIG. 5. The face plate 14 in the open position is approximately perpendicular to the proximal end 17 of the stationary plate 12 to allow unobstructed access to the interior of the frame 8.

In the closed position in FIG. 5, proximal end 42 of face plate 14 contacts flat surface 18 of stationary plate 12. A display sheet (not shown) may extend between the proximal end 42 of face plate and the flat surface 18 of the stationary plate 12. In the closed configuration, the mating feature 44 is still inserted in the corresponding curved recess 28, but has rotated and translated to a proximate position in the curved recess 28. As seen in FIG. 5, mating feature rounded end 48 does not contact with distal end 40 of curved recess. Protrusion 50 contacts motion limiting track proximal end 34 to maintain a portion of the mating feature 44 in the curved recess 28. Mating feature 44 has an interior concave curved surface 53 located on a surface of the mating feature opposite the surface of the protrusion 50. Concave curved surface 53 is shaped to conform to an exterior convex curved surface 54 of the receiver 24 so that the concave curved surface 53 is in continuous contact with the exterior curved surface 54 in the closed position.

In addition, the stationary plate and face plate can be modified for different applications other than billboard frames, such as, but not limited to, for joining any two objects in which a hinge providing relative rotation (e.g., ninety degrees) of two objects may be required.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

It should further be noted that any patents, applications and publications referred to herein are incorporated by reference in their entirety.

What is claimed is:

1. A hinge, comprising:
a) a receiver having a curved interior recess and a motion limiting track located between a proximal and a distal end of the curved interior recess;
b) a mating feature having a curved shape and rounded distal end with a protrusion located proximate to the rounded distal end; and
c) a joint formed between the receiver and the mating feature,
wherein the mating feature is shaped to translate along the curved interior recess of the receiver and the protrusion is configured to translate along the motion limiting track so that the rounded distal end contacts the distal end of the curved interior recess and the protrusion contacts a distal end of the motion limiting track in an opened position.

2. The hinge of claim 1, wherein the motion limiting track is a curved groove within the curved interior recess having a proximal end that contacts the protrusion when the hinge is in a closed position.

3. The hinge of claim 2, wherein the receiver further comprises an exterior convex surface located exterior to the curved interior recess, and the mating feature further comprises a concave surface located on a surface opposite the protrusion, wherein the exterior convex surface continuously contacts the concave surface in the closed position.

4. The hinge of claim 1, wherein the receiver is part of an S-shaped distal end of a first stationary plate and the mating feature is part of a curved face plate that rotates open and closed.

5. The hinge of claim 4, wherein the S-shaped distal end of the stationary plate further includes a load distribution surface, wherein the load distribution surface is proximal to the receiver.

6. The hinge of claim 5, wherein the load distribution surface is a curved surface that continuously contacts an adjacent face surface of the curved face plate when the hinge is in an opened position.

7. The hinge of claim 6, wherein the load distribution surface, the distal end of the motion reducing track, and the distal end of the curved interior recess prevent further movement of the face plate when the face plate when the face plate is moved to the opened position.

8. The hinge of claim 4, further comprising a spring mounted in compression between the receiver and an arm extending from the face plate, wherein the spring biases the hinge system in a closed position.

9. A hinge system for use in a billboard frame comprising:
a) a stationary plate having a receiver with an interior curved recess;
b) a face plate configured to rotate about the stationary plate having a mating feature that extends into the receiver to form a hinge; and
c) a load distribution feature having a curved surface adjacent to the receiver on the stationary plate that supports an adjacent exterior surface of the face plate and is in continuous contact with the adjacent exterior surface when the hinge is in an open position.

9. The hinge assembly of claim 9, wherein the receiver and the load distribution feature form an S-shaped distal end of the stationary plate.

10. The hinge assembly of claim 10, wherein the face plate exterior surface is curved to continuously contact the stationary plate along the load distribution feature.

11. The hinge system of claim 9, wherein the interior curved recess further comprises a motion limiting track recessed in a wall of the interior curved recess having a proximal and distal end, wherein the motion limiting track is shorter than the interior curved recess and the distal end of the motion limiting track is proximal to a distal end of the interior curved recess.

12. The hinge system of claim 12, wherein the mating feature is curved and includes a rounded distal end and a symmetrical protrusion extending from a point proximate to the rounded distal end.

13. The hinge system of claim 13, wherein the rounded distal end, the symmetrical protrusion, and the face plate exterior surface each contact the stationary plate in the open position preventing further movement of the face plate in an opening direction.

14. The hinge system of claim 13, wherein when the hinge system is in the open position, the rounded distal end of the mating feature contacts the distal end of the interior curved recess and the protrusion contacts the distal end of the motion limiting track preventing further movement of the face plate in an opening direction.

15. The hinge system of claim 15, wherein when the hinge system is in a closed position, the protrusion contacts the proximal end of the motion limiting track preventing further movement of the face plate in a closed direction.

16. The hinge system of claim 16, wherein the face plate mating feature further comprises a concave surface and the concave surface continuously contacts a convex surface of the receiver located exterior to the interior curved recess in the closed position.

17. The hinge system of claim 9, further comprising a spring mounted in compression between the receiver and an arm extending from the face plate, wherein the spring biases the hinge system in a closed position.

19. A hinge for use in a billboard frame, the hinge comprising:
a) a stationary plate having a distal receiver with an interior curved recess including a motion limiting track, and a load distribution surface proximal to the distal receiver;
b) a face plate having a proximal exterior surface and a distal mating end that has a distal rounded end and a protrusion extending proximal to the distal rounded end, the face plate forms a joint with the distal receiver end, the joint configured to allow movement of the face plate between opened and closed positions; and,
c) means for preventing further movement in the opening direction when the face plate is in the opened position so that force and load are distributed at multiple points between the stationary plate and the face plate.

20. The hinge of claim 19, wherein the means for preventing further movement comprises contact between the receiver recess and the distal rounded end, contact between the protrusion and a distal end of the motion limiting track, and contact between the load distribution surface and an exterior face surface of the face plate.
